(19) United States
(12) Patent Application Publication
(10) Pub. No.: US 2019/0213521 A1
(43) Pub. Date: Jul. 11, 2019

(54) SYSTEM FOR QUALIFIED ONLINE PROJECT COMPLETION

(71) Applicant: William A. BOSSEN, Los Angeles, CA (US)

(72) Inventor: William A. BOSSEN, Los Angeles, CA (US)

(21) Appl. No.: 16/246,128

(22) Filed: Jan. 11, 2019

Related U.S. Application Data
(60) Provisional application No. 62/616,214, filed on Jan. 11, 2018.

(51) Int. Cl. G06Q 10/06; G06Q 50/18; G06Q 40/00

(52) U.S. Cl. CPC G06Q 10/06398; G06Q 40/125; G06Q 10/06311; G06Q 50/18

(57) ABSTRACT

System for attorneys to post projects online which may be completed in exchange for payment by qualifying pre-screened law clerks, attorneys and paralegals described interchangeably herein collectively as “Law Clerks.” Law Clerks are paid a pre-determined fee for completion of the project and, under some circumstances, can bid on the amount they are to be paid for completion of a project. Law Clerks are given feedback by the attorney posting the project (“Posting Attorney”) which results in a rating. This rating and other criteria, including those based upon education, work experience and review of writing samples and previous work product, may be used by the Posting Attorney to pre-screen Law Clerks who are qualified to accept the project. This system provides a way for attorneys to obtain completion of specific projects suitable for a Law Clerk without incurring the financial burdens associated with recruiting and employment of an individual on a full or part-time basis. The system provides an opportunity for Law Clerks to obtain work and that work may be completed at a convenient pace and in a setting of their choice. The system also provides a basis for Law Clerks to obtain experience in the legal profession and feedback on their work product from Posting Attorneys.

### CROSS-REFERENCE TO RELATED APPLICATIONS

This application claims the benefit of U.S. provisional application No. 62/616,214 filed on Jan. 11, 2018 and titled, “System for Qualified Online Project Completion.” The entire contents of all related applications are incorporated by reference herein.

### FIELD OF INVENTION

The present invention relates to law practice management, work placement and recruiting for attorneys, law clerks and paralegals, and more particularly an automated method for attorneys to efficiently and quickly assign projects to and obtain work product from qualified Law Clerks.

### BACKGROUND OF INVENTION

Attorneys are sometimes in need of the services of a Law Clerk, but such need is on a sporadic basis or other considerations render it impractical to hire a full time Law Clerk for the given project. Circumstances exist where all sizes and types of law firms may, from time to time, need the services of a Law Clerk, perhaps on an expedited or after hours basis, and existing law firm staff cannot meet the need. At present, there is often no means to locate assistance needed on a timely basis without incurring the obligations and burdens associated with an employment relationship.

Practitioners also sometimes lack the ability to locate qualified Law Clerks because of the absence of such individuals living in the geographic area or any qualified Law Clerks in the area are otherwise employed and occupied. For example, projects for a medical malpractice case may best be completed by a Law Clerk who previously worked as a nurse or has medical training and no such person may reside locally. Circumstances also arise where the services of a Law Clerk are needed on an emergency basis with short deadlines and/or involve issues to which local staff cannot respond. It is an axiomatic that a multitude of circumstances exist which the assistance of a Law Clerk would be helpful, but the candidate is not available or cannot otherwise be easily located and retained. The present invention provides the basis for an attorney to locate needed assistance online from Law Clerks who have immediate capacity and may have needed experience or training not held by those who are available for such work in the geographical area of the attorney.

### SUMMARY OF INVENTION

The present invention provides a system for a Posting Attorney to post a legal project suitable for completion by a Law Clerk to an online list. The project listings available for review by Law Clerks would include a brief description of the project, the deadline for completion of the project, the amount to be paid to the clerk on completion and whether bids for greater compensation are accepted. If interested in the project, the Law Clerk may review a detailed project description.

Postings are available for review and acceptance by Law Clerks. Once a project is accepted by a Law Clerk, it is removed from the list of available projects. After final acceptance or review of the entire project and the determination that no conflicts of interest exist, the project is completed by the Law Clerk. On successful completion of the project, the Law Clerk is paid the amount which the Posting Attorney agreed to pay for the work product and a commission is paid to the web host. The amount which the Law Clerk is paid for services resulting in project completion may be subject to bid by clerks, at the option of the Posting Attorney. After project completion, the Posting Attorney may rate the project and provide feedback to the Law Clerk.

The system allows the Posting Attorney to set criteria which limit and pre-screen the Law Clerks who access the project on their project lists. Law Clerks may be screened based on a variety of factors relating to educational background, academic success, work history, feedback rating and other criteria established by the Posting Attorney.

The system allows cost savings and additional work resources to member Posting Attorneys who may forego costs of recruiting and employment of Law Clerks on a full or part-time basis. The Posting Attorney may also be able to hire a Law Clerk with skills or experience not otherwise available in the community of the Posting Attorney. Law Clerks obtain the ability to work for hire at the time and place they choose. A new source of income is available to Law Clerks as a result of the website.

It is to be understood that both the foregoing general description and the following detailed description are exemplary, explanatory and intended to provide further explanation of the invention.

### BRIEF DESCRIPTION OF THE DRAWINGS

The accompanying drawings, which are included to provide a further understanding of the invention and are incorporated in and constitute a part of the specification, illustrate embodiments of the invention and together with the description serve to explain the principles of at least part of one embodiment of the invention.

In the drawings are:

FIG. 1 is a block diagram generally illustrating the system and method for membership registration and the membership registration process according to an embodiment of the present invention.

FIG. 2 is a screen shot of an embodiment of the invention showing certain aspects of the membership registration form.

FIG. 3 is a diagram generally illustrating functions of the invention following membership registration according to an embodiment of the present invention.

FIG. 4 is a screen shot of an embodiment of the invention showing a Project List available to a qualifying member Law Clerk.

FIG. 5 is screen shot of an embodiment of a Detailed Project Description available to a qualifying Law Clerk.

FIG. 6 is a block diagram generally illustrating an embodiment of the system whereby the Law Clerk may bid for more compensation to complete an item on the Project List.

FIG. 7 is a block diagram of the process for confirming the absence of conflicts of interest created by the Law Clerk's work on a project according to an embodiment of the present invention.

FIG. 8 is a screen shot of an embodiment of the invention showing an email sent by the Web Host to the Law Clerk to address possible conflicts of interest.

FIG. 9 is a block diagram illustrating the features of the pending Project Portal according to an embodiment of the present invention.

FIG. 10 is a screen shot of an embodiment of the invention showing various aspects of the Project Portal.

FIG. 11 is a block diagram of the system for the Posting Attorney to provide feedback for a Law Clerk and rate the work product according to an embodiment of the present invention.

FIG. 12 is a screen shot consisting an embodiment of the invention depicting various aspects of the Project Submission Form.

FIG. 13 is a block diagram of an embodiment of the invention depicting the system for pre-screening Law Clerks eligible for a project.

FIG. 14 is a screen shot of an embodiment of the invention depicting a List of Biographical Profiles of Law Clerks to be considered by Posting Attorneys when pre-screening Law Clerks for projects.

### DETAILED DESCRIPTION OF THE PREFERRED EMBODIMENTS

Reference will now be made in detail to the preferred embodiments of the present invention, examples of which are illustrated in the accompanying drawings.

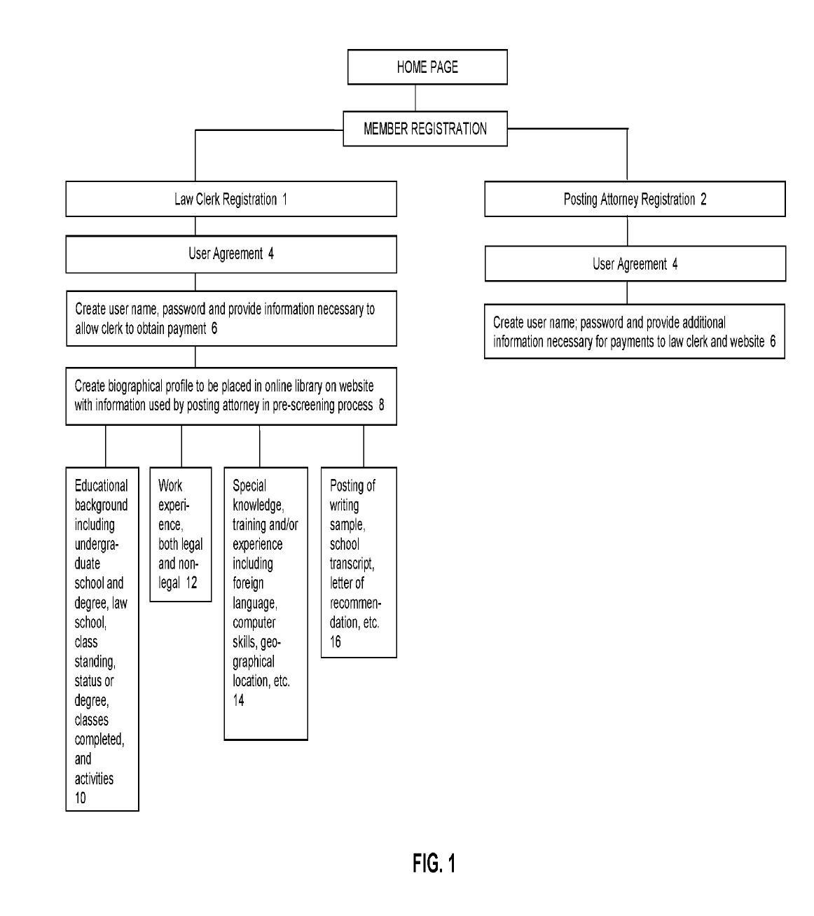

Referring to FIG. 1, a block diagram generally illustrating registration to use the present invention. A website home page enables users to elect to register as a member of the system. Users are initially requested to register as either a Law Clerk 1 seeking work for compensation or a Posting Attorney 2 seeking to post projects to be completed by Law Clerks.

As part of the registration process, Law Clerks and Posting Attorneys must approve the user agreement. 4 Law Clerks and Posting Attorneys also must create a user name and password for access to the present invention and provide information necessary to accept or make payments for work by Law Clerks and commissions to the Web Host. 6 The Law Clerk registration also allows the registrant to provide background information used to pre-screen Law Clerks for projects and to create a Law Clerk Biographical Profile. 8 Requested background information includes educational background such as undergraduate school, law or paralegal school, level of advancement in law school (i.e. first year, second year, etc.), class rank (i.e. top 5%, top 10%, etc.), grade point average, classes completed (i.e. evidence, contracts, corporations, etc.), activities (i.e. law review, moot court, etc.) certifications and related information. 10

The registering Law Clerk also may provide information relating to legal work experience including public sector legal work (i.e. law clerk for a federal judge, law clerk for state court judge, law clerk for SEC, etc.) and private sector legal work (i.e. law clerk for large firm, law clerk for small firm, law clerk for large corporation, etc.). 12 The Law Clerk may also identify non-legal work experience (i.e. nurse, contractor, soils engineer, etc.). 12

The Law Clerk also may identify types of special knowledge, skills or training including foreign languages, computer training and related skills. 14

The Law Clerk may also post writing samples of prior work product, school transcripts, letters of recommendation and other materials for consideration by Posting Attorneys. 16

In a non-illustrated embodiment, the system includes a “background” check to confirm the information submitted by the Law Clerk is correct, such as verifying the Law Clerk's school, grades, class rank, and experience.

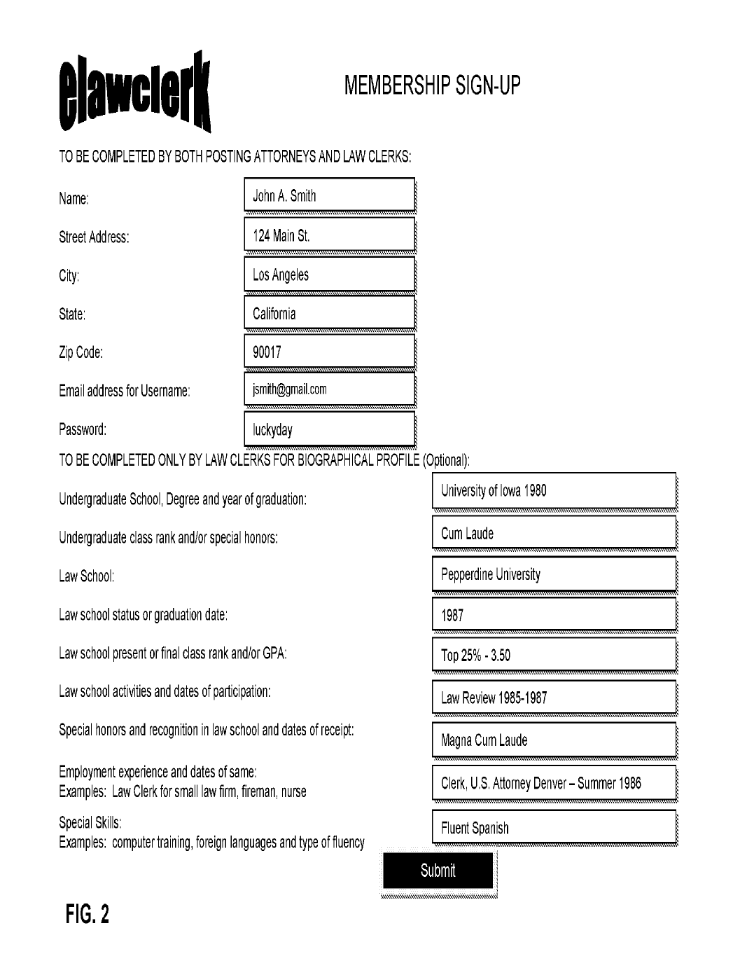

FIG. 2 is a non-limiting example constituting a screen shot of certain aspects of the membership registration form according to an embodiment of the present invention.

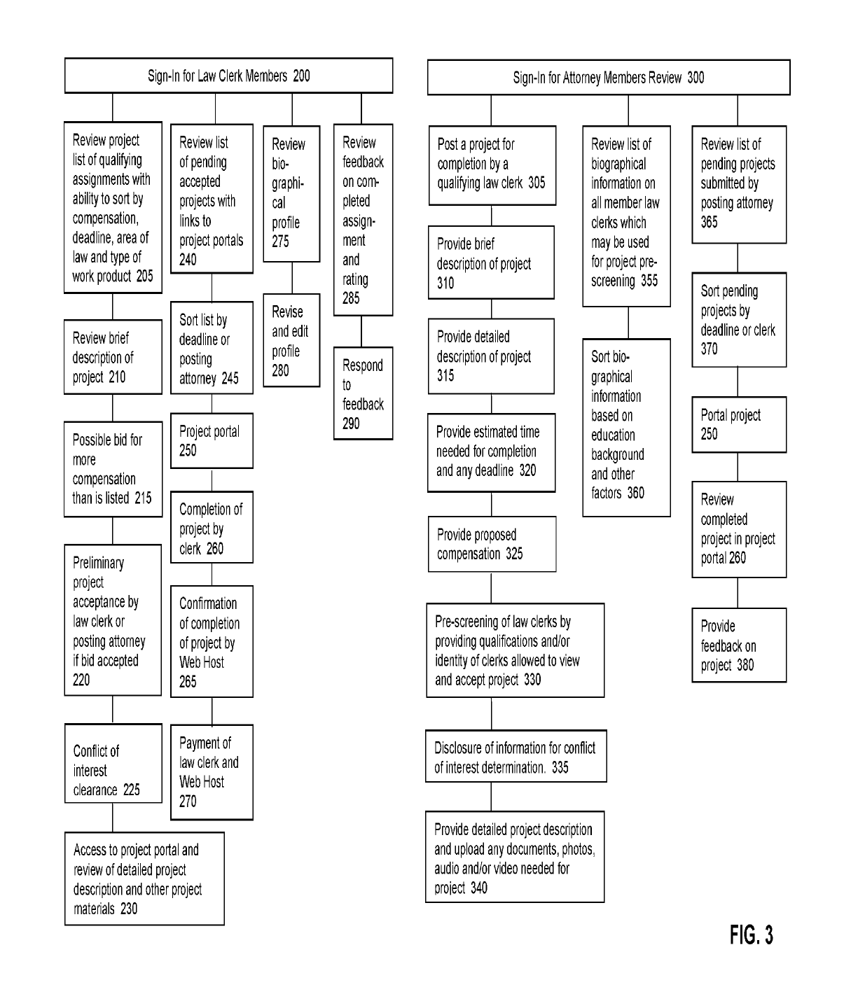

Referring to FIG. 3, a block diagram generally illustrating the functions of the invention for Posting Attorneys and Law Clerks after they have registered as members and signed-in to the present invention. 200 Features of the present invention available to Law Clerks are listed on the four left columns and features available to Posting Attorneys are listed on the four right columns.

Law Clerks may review a list of projects submitted by Posting Attorneys which are available to them for acceptance and completion for compensation. 205 This is referred to as the Project List. Each entry on the Project List sets forth a brief description of the project, the amount of time the Post Attorney estimates it will take to complete the project, the deadline for completion of the project, and the amount which the Law Clerk will paid for completing the project. The Law Clerk can sort the projects on the Project List for which he or she qualifies based on compensation (highest/lowest, first), deadline (soonest/latest), area of law (i.e. criminal, personal injury, bankruptcy, etc.) and type of work required (i.e. memorandum of law, deposition summary, preparation of draft discovery responses for attorney review, etc.). Law Clerks may also search the Project List by keyword. Upon selection of any brief project description listed on the Project List, the Law Clerk may obtain a Detailed Project Description which they may consider in deciding whether to preliminarily accept the project. 210 After reviewing the Detailed Project Description, the Law Clerk is given the option of making a bid to complete the project for more compensation than offered 215 or preliminarily accepting the project. 220 The Law Clerk also may elect to go back to the project list after reviewing the brief description of the project.

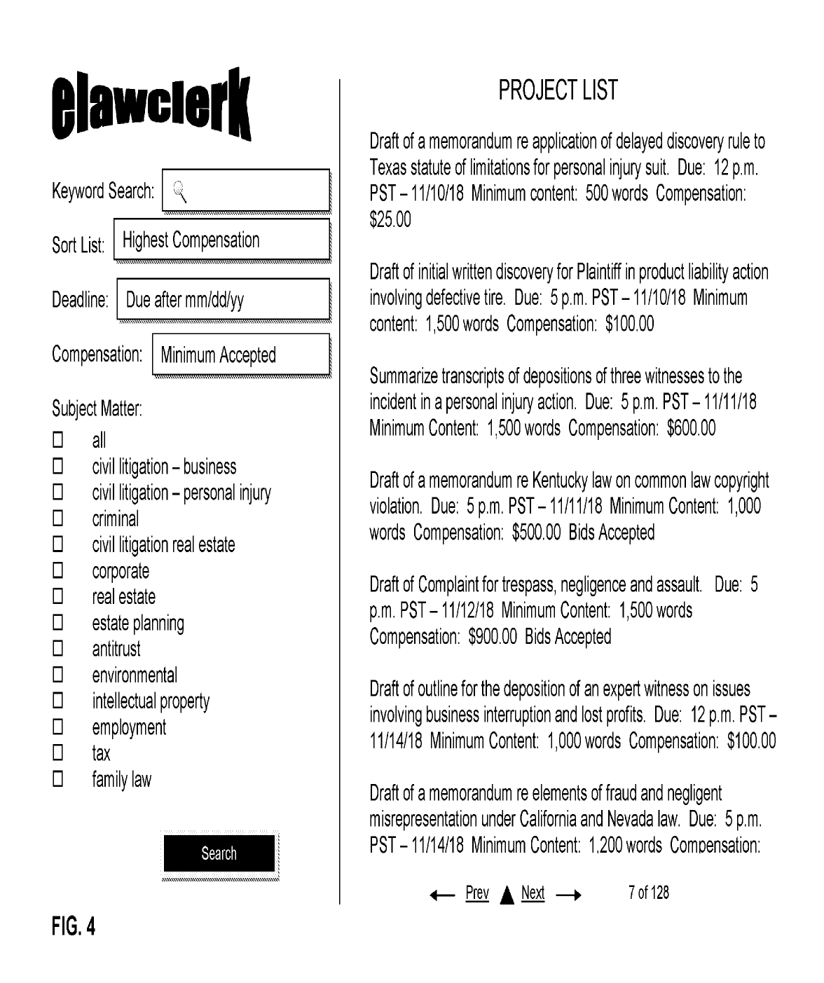

FIG. 4 is a non-limiting example constituting a screen shot of certain aspects of the Project List which is available to a member Law Clerk who otherwise qualifies for the projects listed pursuant to criteria selected by the Posting Attorney at the time of project submission.

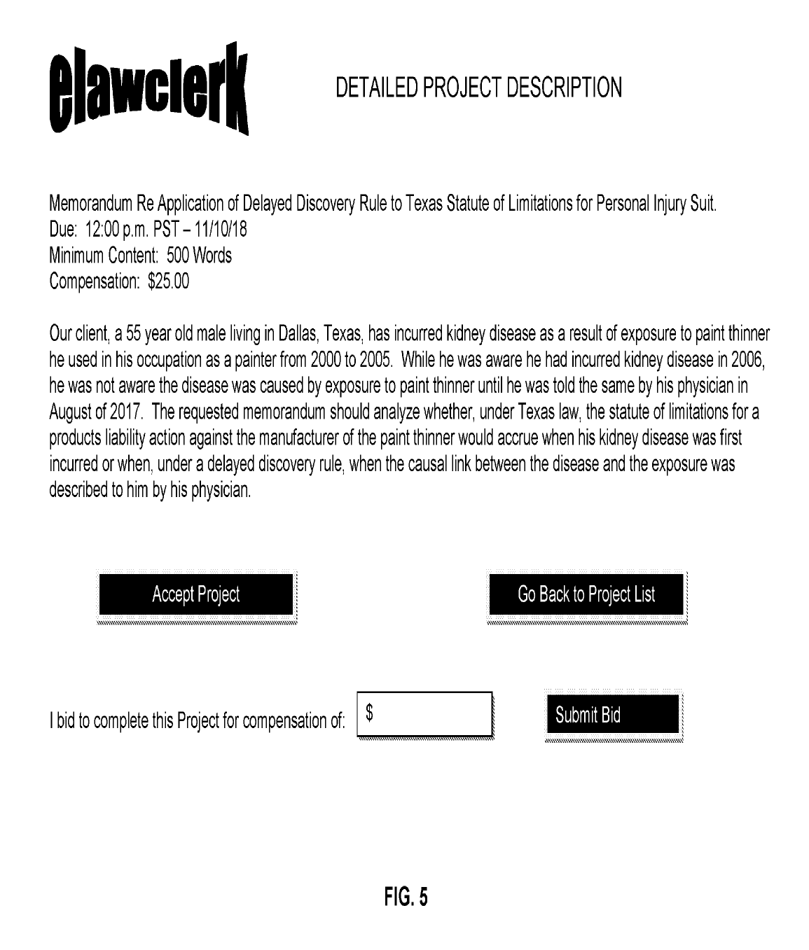

FIG. 5 constitutes a screen shot of an example of the Detailed Project Description and other options available to the qualifying Law Clerk upon consideration of the Detailed Project Description.

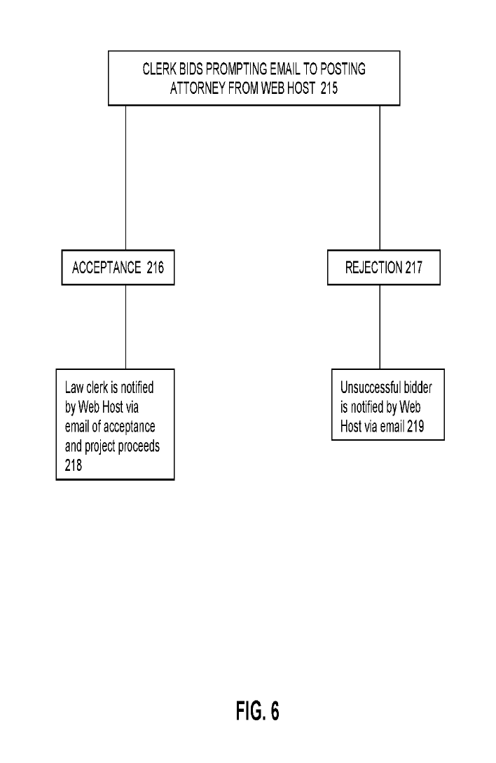

FIG. 6 is a block diagram generally illustrating the system which, if authorized by the Posting Attorney, allows the Law Clerk to bid for more compensation than is listed as available by the Posting Attorney on the pending Project List. 215 When a bid is made, an email from the Web Host is sent to the Posting Attorney authorizing them to accept or decline the bid. The Posting Attorney must reply to the email and accept 216 or reject 217 the bid. The Law Clerk is then advised by the Web Host of the acceptance or rejection of the bid. The project proceeds upon acceptance of the bid by the Posting Attorney. 218 If the bid is rejected, the project remains on the list of pending projects of qualifying Law Clerks. 219

Returning to FIG. 3, when a Law Clerk preliminarily accepts a project or a Posting Attorney accepts a Law Clerk's bid, the project is removed from the list of available projects for all Law Clerks who also otherwise qualify for the project, subject to relisting the project if final acceptance and successful project completion are not otherwise achieved by the Law Clerk who preliminarily accepts the project. 220

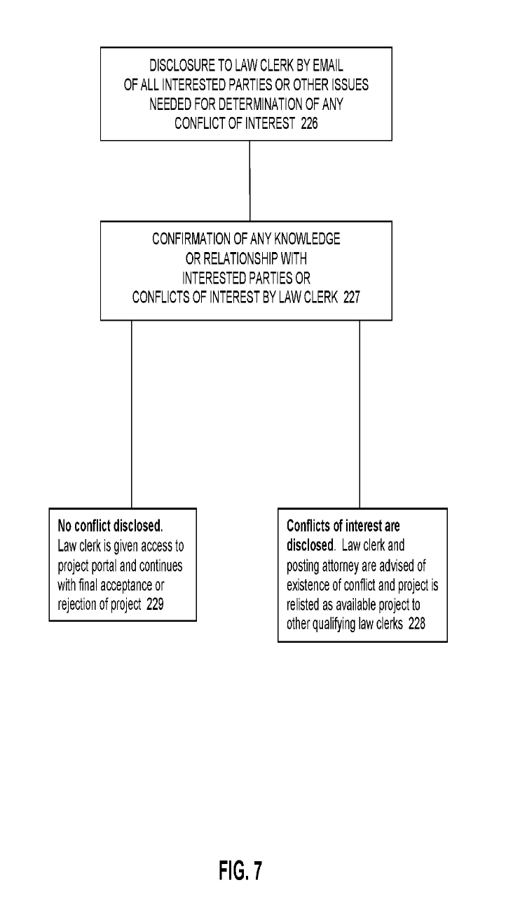

Referring to FIG. 7, a block diagram generally illustrating the system under which information needed for the identification of conflicts of interest by the Law Clerk. Upon the election by a Law Clerk to preliminarily accept a project, an email is delivered to the Law Clerk containing information from the Posting Attorney, including the names of all interested parties, counsel and witnesses necessary for consideration by the Law Clerk in determining whether a conflict of interest must be disclosed. 226 The Law Clerk is then required to confirmed whether any conflicts of interest exist based on the information provided. 227 Upon disclosure of a conflict of interest, the project is deemed rejected by the Law Clerk and is returned to the list of available projects for other qualifying Law Clerks. 228 If no conflicts of interest are disclosed, the Law Clerk is given access to the Project Portal and the project proceeds. 229

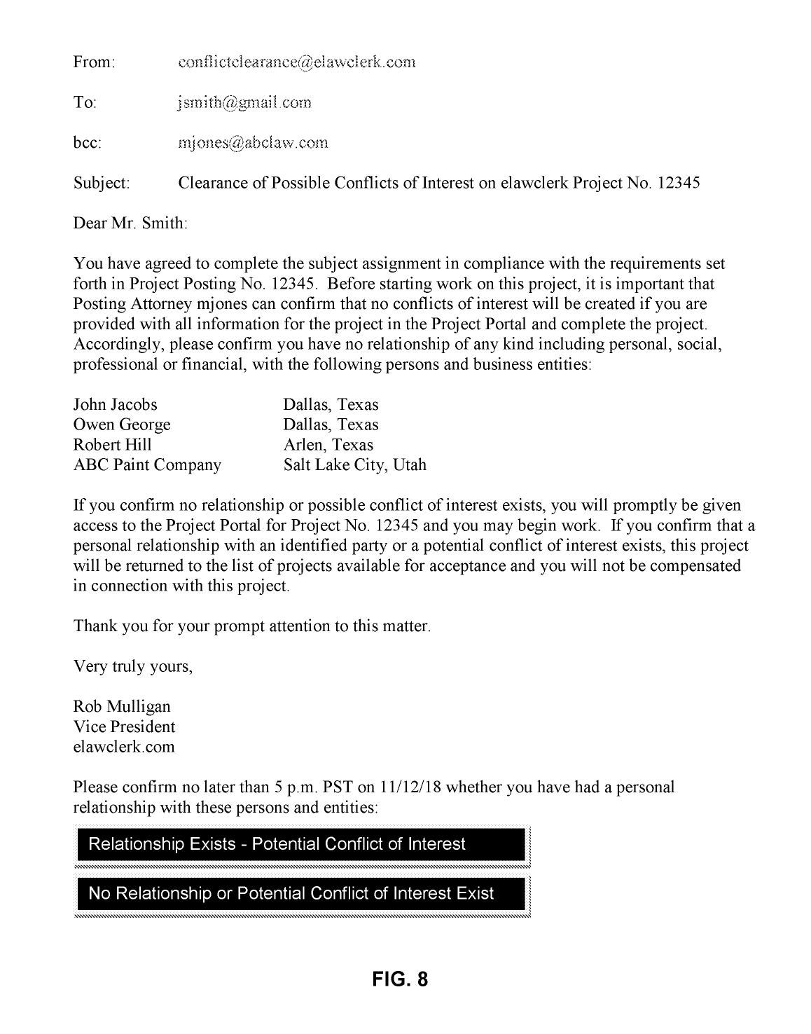

FIG. 8 is a non-limiting example of an email sent to the Law Clerk setting forth the names of all interested parties, witnesses and counsel identified by the Posting Attorney is necessary for consideration in determining whether a conflict of interest exists. The email sets forth options to the Law Clerk for confirming that a conflict of interest exists or does not exist based upon whether the Law Clerk has knowledge of any of the identified parties, witnesses and counsel provided by the Posting Attorney.

Returning to FIG. 3, upon confirming that no conflict of interest exists, the Law Clerk is given access to the Project Portal and is able to review the project materials including documents, video recordings, audio recordings and photos which the Posting Attorney considers necessary for consideration and completion of the project. 230

Law Clerks may also review a List of Pending Projects which they have previously accepted, setting forth the project titles, deadlines and estimates of time required for completion. 240 The listed project titles serve as links to the Project Portal for those projects. The Project List may be sorted by the Law Clerk using various criteria including completion deadline and Posting Attorney. 245

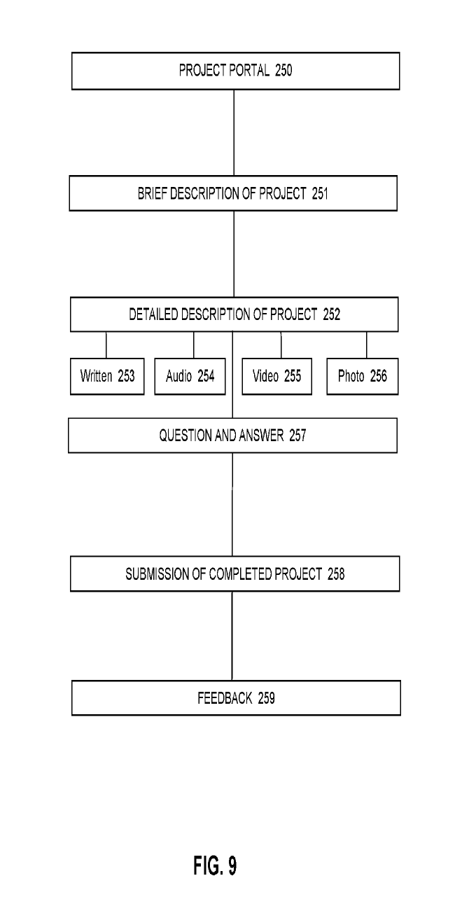

FIG. 9 is a box diagram illustrating the general features of the Project Portal. The Project Portal 250 will set forth the brief project description 251, detailed project description 252 and any additional materials submitted by the Posting Attorney for review by the Law Clerk who accepted the project including documents 253, audio recordings 254, video recordings 255 and photographs 256.

The Project Portal will also contain an option enabling the Posting Attorney and Law Clerk to communicate with each other about the pending project. 257 This option will also allow the Posting Attorney and the Law Clerk to post written questions and responses.

The Project Portal will also allow the Law Clerk to submit the work product created in connection with the project to the Posting Attorney. 258

When all work product has been submitted, an email notification of the same is sent to the Posting Attorney. Thereafter, the Posting Attorney may review the completed project in the Project Portal. The Posting Attorney may thereafter leave feedback on the project. 259

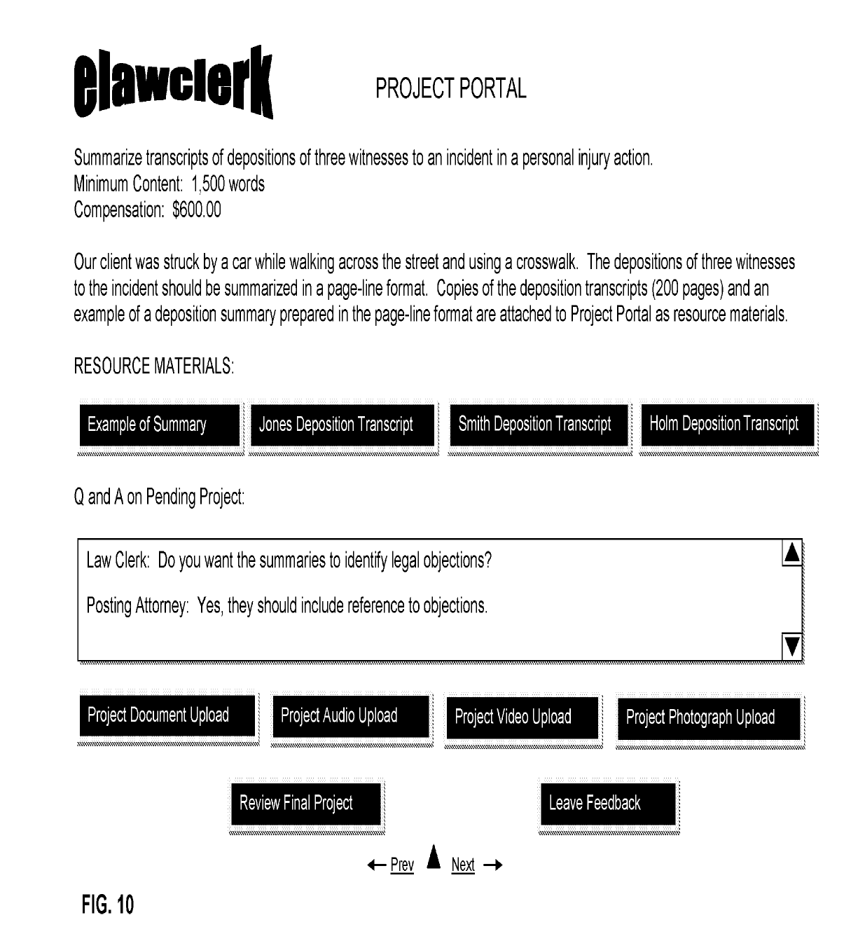

FIG. 10 is a non-limiting example of a screen shot illustrating various perspectives of the Project Portal from the user interface perspective.

Returning to FIG. 3, following confirmation of completion of the project by the Law Clerk, the Web Host determines whether the submission by the Law Clerk has occurred and meets objective criteria required for payment. 265 Thereafter, qualifying payments by the Posting Attorney to the Law Clerk and Web Host are processed by the Web Host. 270

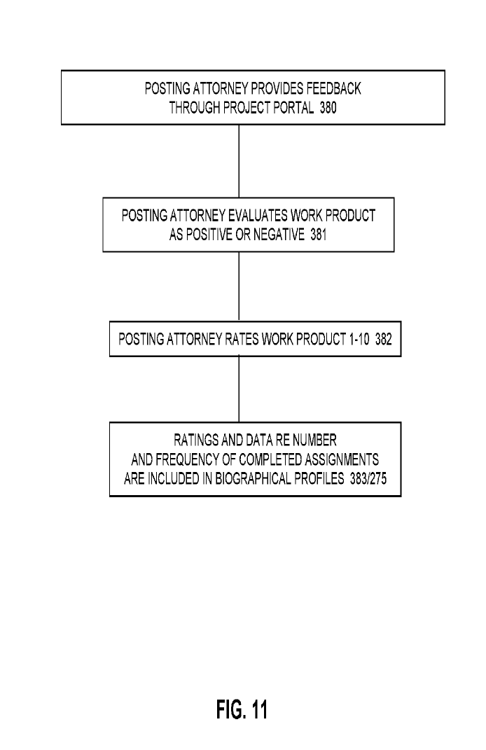

FIG. 11 is a box diagram illustrating the feedback functions of the invention. Following completion of a project, the Posting Attorney is provided access to feedback functions of the Project Portal. 380 The Posting Attorney evaluates the work product as positive or negative 381 and rates it on a 1-10 basis. 382 The data is then utilized to calculate a feedback rating. The Post Attorney may also post written comments and review the work product in detail to provide guidance to the Law Clerk. 383/275

Returning to FIG. 3, the feedback rating, written comments and information relating to the number of assignments which a Law Clerk has successfully completed are available in the Law Clerk's Biographical Profile 275 which may be reviewed by Posting Attorneys in determining assignment qualification. 355 The Law Clerk's biographical profile may be updated to note changes or additions of information. 280 The Law Clerk may review and respond to feedback left by Posting Attorneys when reviewing and editing their Biographical Profile. 285-290

In a non-illustrated embodiment, the Law Clerk can provide feedback on the Posting Attorney.

Continuing with FIG. 3, the project is first submitted by the Posting Attorney who utilizes a project submission form available after sign-in. 305

The Posting Attorney submits a short description of the project, not exceeding a specified number of characters. 310 The Posting Attorney also submits a more detailed description of the project, not exceeding a specified number of characters. 315 The Posting Attorney also submits an estimate of the time he reasonably expected to complete the assignment and submit the required work product and any deadline. 320 The Posting Attorney also sets the compensation which will be paid to the Law Clerk upon successful completion of the project.

The Posting Attorney may pre-screen prospective Law Clerks and provide the qualifications of the Law Clerks who are provided access to the project on their project list and are otherwise qualified to accept the project. 330

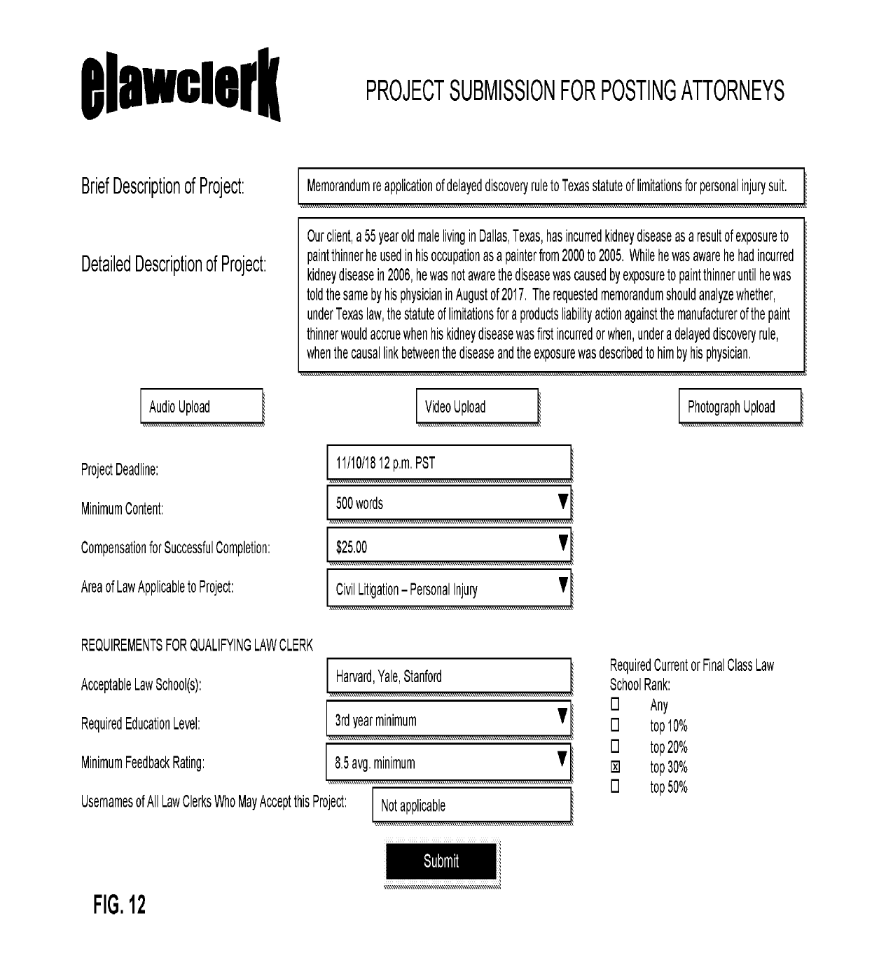

FIG. 12 is a non-limiting example of a screen shot which depicts various aspects of the Project Submission Form.

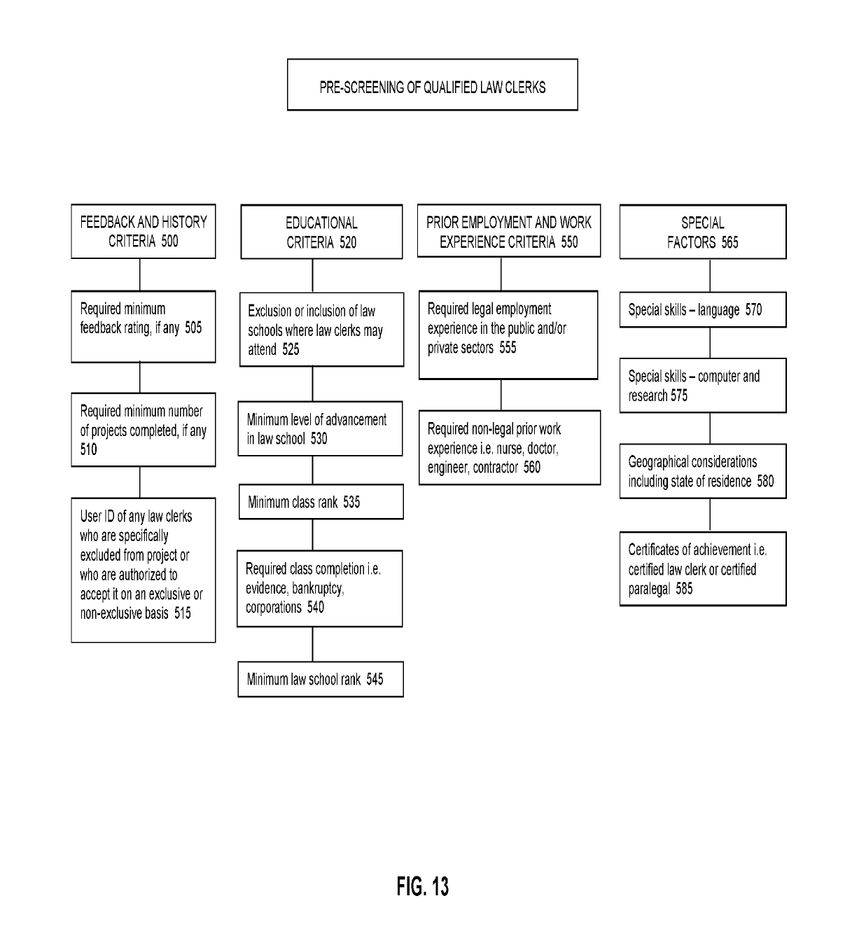

FIG. 13 is a block diagram providing an illustration of various criteria which may be considered in pre-screening Law Clerks who are otherwise qualified to obtain access to and accept a given project.

The Posting Attorney may set criteria regarding the minimum feedback rating and work history for Law Clerks who may accept a posted project. 500-510 The Posting Attorney may also indicate the user names of any and all Law Clerks for which the assignment is either excluded or included on their project list. 515

The Posting Attorney may also set forth specific educational criteria required of the Law Clerk who is qualified to review and accept the project. 520 The Post Attorney may specifically include or exclude Law Clerks who attend a particular law school. 525 The Post Attorney may also set qualifications based upon the Law Clerk's level of academic advancement (i.e. college graduate, first year law student, second year law student, etc.) 530, minimum class rank (i.e. top 5%, top 10%, top 25%, etc.) 535, required class completion (i.e. evidence, torts, contracts, bankruptcy, etc.) 540, and minimum law school rank (i.e. U.S. News and World Report top 10%, U.S. News and World Report top 20%, etc.) 545.

The Posting Attorney may also require that qualifying Law Clerks meet minimum criteria based on prior employment 550 including prior legal work experience in the public section (i.e. law clerk for a state court judge, law clerk for a federal judge, etc.) and private sector experience (i.e. law clerk for a small law firm, law clerk for a large law firm, law clerk for a corporation, etc.) 555. The Posting Attorney may also require that a qualifying Law Clerk meet minimum criteria based on prior non-legal employment including work in a specific industry or occupation (i.e. nurse, doctor, engineer, etc.). 560

Other special skills and considerations of the Law Clerk may also be considered by the Posting Attorney in establishing the qualifications of Law Clerks who may review and accept their projects including foreign languages 570, computer skills 575, geographical considerations 580, certifications and other factors 585.

Returning to FIG. 3, the Posting Attorney must disclose all interested parties, counsel, witnesses and others needed for consideration of conflicts of interest. 335 The procedure for determining whether a conflict of interest exists and the disclosure of such information to the Law Clerk is discussed above.

The Posting Attorney must provide a detailed description of the project including all facts, information and materials necessary for completion of the assignment within the deadline provided and within the estimated time allocation for the same. The Posting Attorney must also post any and all other documents (i.e. deposition transcripts, complaints, contracts, etc.), video recordings, audio recordings (via telephone) or photographs which are needed for completion of the project. 340

Payment for the services of the Law Clerk and commission to the Web Host are made on confirmation of project completion by the Web Host. The payment source is identified by the Posting Attorney when the project is first posted and is secured by the Web Host upon final acceptance of the project by the Law Clerk. 350

In a non-illustrated embodiment, the system further includes a financial module. The financial module is used to facilitate payment from the attorney to the Law Clerk upon completion of the project. In some embodiments, the financial module includes an escrow account or trust account to hold the payment until completion of the project. In this embodiment, once the project is completed, then the funds are released to the Law Clerk. In other embodiments, the financial module includes security features that allows for secured payment transactions such as direct deposit, credit card transactions, and the like. In another embodiment, the financial module works with 3^{rd} party payment transaction systems such as Paypal, Venmo, Stripe, Transferwise, Google Wallet, Shopify, Payoneer, Authorize.net, Payline, Square, Amazon Pay, Braintree, Intuit, WePay, 2CheckOut, ProPay, Click2Sell, Dwolla, Skrill, Klarna, Payza, Merchant, and the like. In another embodiment, the financial module securely stores the payment information for the all parties. In another embodiment, the financial module stores the payment transaction information for future reference, e.g. if there is a dispute in payment.

The Posting Attorney may review a list of all Law Clerk Biographical Profiles to determine the identify of Law Clerks who are qualified for projects to be submitted. 355 The Posting Attorney may sort the biographical information based upon educational criteria, work experience, feedback rating and other criteria. 360 In a non-illustrated embodiment, Law Clerks that the Posting Attorney has used in the past are listed at the top of the qualified Law Clerks lists.

The Posting Attorney may also review a list of pending projects which that attorney has submitted. 365 This list may be sorted by completion deadline or the identity of the Law Clerk completing the assignment if it has been accepted by a Law Clerk. 370

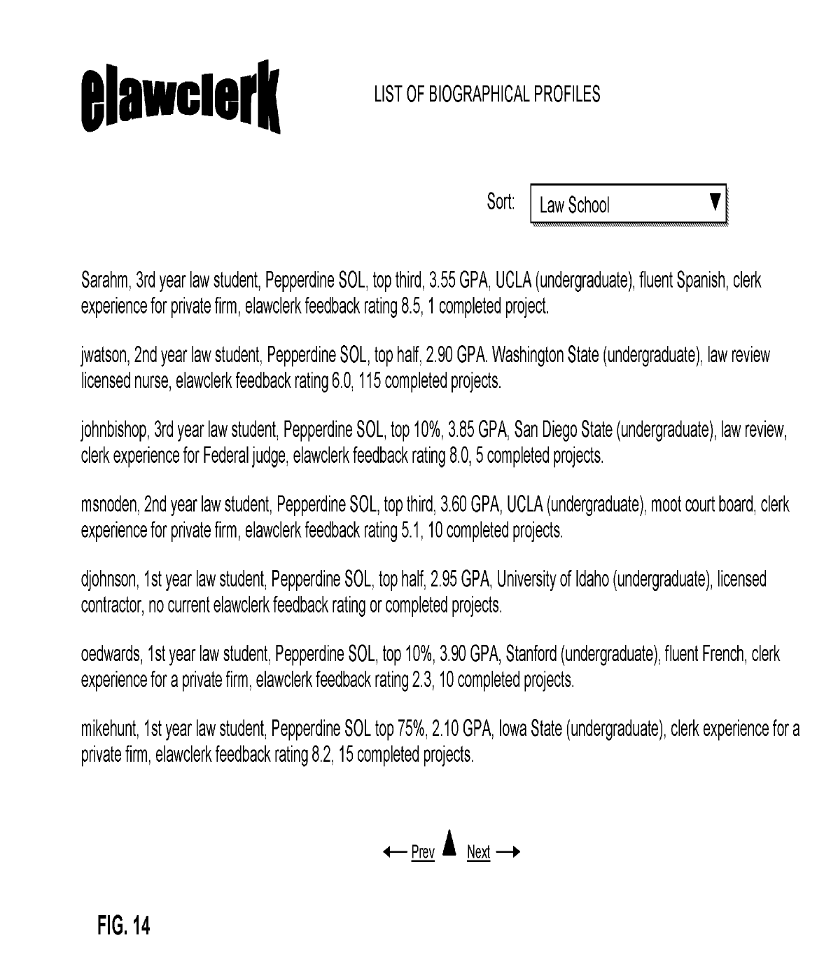

FIG. 14 is a non-limiting example of a screen shot of the List of Biographical Profiles which may be reviewed by the Posting Attorney. The list sets forth the Law Clerk's user names, law school, status in law school (i.e. first year, second year, etc.) and class rank.

In a non-illustrated embodiment, the system includes Paralegals in addition to or in place of Law Clerks.

In a non-illustrated embodiment, the system includes security features to keep all information about the parties, projects, clients, and the like confidential. In some embodiments, the security features are virtual such as encryption, digital signatures, Public Key Cryptography/Public Key Infrastructures, virtual private network, and the like. In other embodiments, the security features are physical.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

1. A system for qualified online project completion, the system comprising:
a registration module for at least one law clerk and at least one posting attorney registration;
a project receiving module configured to receive information of a first legal project by a at least one posting attorney, the first legal project including a brief description, a detailed description, a deadline for completion of the first project, a predetermined amount to be paid to the law clerk on completion, and a pre-screening module for receiving criteria by the at least one attorney;
a project posting module in communication with the project receiving module, configured to post information of a first legal project by the at least one posting attorney wherein the project posting module limits a plurality of law clerks according to criteria specified in the pre-screening module;
a conflict module configured to receive the disclosure of conflict of interest information from the law clerk and compare the conflict of interest information to a pre-determined database of conflict of interest information upon the acceptance of the first legal project by the at least one law clerk wherein the first legal project is removed from the project posting module upon the acceptance; and
a project completion module configured to receive a completed first legal project by at least one law clerk and transmit the predetermined amount to the at least one law clerk.

2. The system of claim 1, wherein the registration module includes a background check feature.

3. The system of claim 1, wherein the project completion module includes a feedback feature.

4. The system of claim 1, wherein the project posting module allows a pre-screened law clerk to place a bid on the first legal project.

5. The system of claim 1, further comprising a project portal, wherein the project portal facilitate transfer of materials and work product and communication between the posting attorney and the law clerk.

6. The system of claim 1, further comprising a financial module, wherein the financial module facilitates payment of the predetermined amount at the completion of the project.

7. The system of claim 6, wherein the financial module includes a trust or escrow account to hold the predetermined amount until the completion of the project.

8. The system of claim 1, further comprising a security feature to keep all information confidential.
